(19) United States
(12) Patent Application Publication
(10) Pub. No.: US 2012/0037785 A1
(43) Pub. Date: Feb. 16, 2012

(54) Spring arm device

(75) Inventors: Hongbing XU, GUANGDONG (CN); Jingxing SANG, GUANGDONG (CN)

(73) Assignee: MOVCAM TECH. CO., LTD., GUANGDONG (CN)

(21) Appl. No.: 13/038,399

(22) Filed: Mar. 2, 2011

(30) Foreign Application Priority Data
Aug. 12, 2010 (CN) 201010252148.6

(51) Int. Cl. F16F 1/00

(52) U.S. Cl. 248/571

(57) ABSTRACT

The invention provides a spring arm device, comprising: a parallelogram linkage mechanism composed of a mobile side, a fixed side in parallel with the above-mentioned mobile side, an upper arm and a load arm respectively connected with the mobile side and the fixed side; a spring, one end of which is connected with the fixed side or the upper arm while the other end is connected with the mobile side or the load arm or the hinge joint between the mobile side and the fixed side; a pull rod used for installing the above-mentioned spring; a copular axle used for positioning the above-mentioned pull rod and a retainer used for installing the above mentioned copular axle; wherein, the above-mentioned retainer is positioned on the mobile side, or on the load arm or on the hinge joint between the mobile side and the load arm. Through a design to the copular axle and the retainer, the device ensures that the copular axle dynamically changes its position during rolling motion, and finishes geometric compensation for the spring's tensile force, thus realizing isoelasticity property. The device has the advantages of simplifying structure, reducing production cost, improving reliability and simplifying operation.

### BACKGROUND OF THE INVENTION

The invention relates to a load-bearing videographic or cinematographic device, in particular to a vibration-absorbing spring arm device for video or film cameras.

In mobile videography or cinematography, a camera stabilizer, by means of the spring arm device, eliminates the vibration generated during motion and ensures the camera to take stable and smooth pictures. The technique is put forward in US patents as below: U.S. Pat. No. 4,208,028, U.S. Pat. No. 5,360,196 and U.S. Pat. No. 7,618,016.

At present, the spring arm of camera stabilizer is essentially divided into two kinds: a spring arm without isoelasticity property and a spring arm with isoelasticity property.

The spring arm without isoelasticity property is characterized by installing one or a plurality of springs at the diagonal (or corresponding position) of a planar four-side linkage mechanism and utilizing change of length and angle of the diagonal of the planar four-side linkage mechanism during operation process to stretch or compress the spring, thus realizing the purpose of vibration absorption. The elastic properties of the spring arm of this type are characterized by stiffness and inadequate flexibility of the spring arm. Obviously different buoyance is generated by the spring arm due to changes of weight of the camera it carries, which greatly affects the vibration-absorbing effect of the spring arm. During filming process, more physical strength is required to raise or lower the spring arm, which increases the difficulty for operators.

The spring arm with isoelasticity property, based on the planar four-side linkage mechanism of the spring arm without isoelasticity property, is additionally provided with a mechanism to amend deformation of the spring, which ensures the spring arm better flexibility and better vibration-absorbing effect. The mechanism amended can ensure that the spring arm provide almost invariable buoyancy which does not obviously change with different weights of the cameras the spring arm carries.

The spring arm structure put forward in U.S. Pat. No. 7,618,016 discloses a technical scheme of isoelasticity effect. The technical scheme is characterized in that a parallelogram linkage mechanism is provided with an isoelasticity-adjusting device on the fixed side. Through the isoelasticity-adjusting device, the isoelasticity status of the spring arm can be amended at high or low spots; the length and angle of the spring can be changed dynamically by the isoelasticity-adjusting device driven by the change of angles of the upper arm and the fixed side, thus realizing isoelasticity effect. The spring arm structure is characterized in that the endpoint of the spring connecting with the first end of the load arm is the copular axle fixed by the retainer; the spring rotates by centering on the copular axle, with the center remaining unchanged in relation to the copular axle in rotation. But the spring arm has the disadvantages of complicated structure, variety of components, high production cost and potential impact on reliability of the device. Besides, the spring arm needs the isoelasticity-adjusting device to realize the isoelasticity properties at high and low spots, which leads to complicated operation.

### BRIEF SUMMARY OF THE INVENTION

The invention provides a vibration-absorbing spring arm device characterized by simple structure, simple operation and high reliability, which can dynamically give a geometric compensation for the spring's tensile force.

In order to reach the above purposes, the invention provides the technical scheme as follows:

A spring arm device is characterized by comprising: a parallelogram linkage mechanism composed of a mobile side, a fixed side in parallel with the above-mentioned mobile side, an upper arm and a load arm respectively connected with the above-mentioned mobile side and the above-mentioned fixed side;

a spring, one end of which is connected with the above-mentioned fixed side or the upper arm while the other end is connected with the above-mentioned mobile side or the load arm or the hinge joint between the mobile side and the load arm;

a pull rod used for installing the above-mentioned spring,

a copular axle used for fixing the above-mentioned pull rod and a retainer used for installing the above-mentioned copular axle;

wherein, the retainer is positioned on the mobile side, or on the load arm, or on the hinge joint between the mobile side and the load arm.

Wherein, preferentially, the force point of the spring on the mobile side or on the load arm or on the hinge joint between the monile side and the load arm shifts with the motion of the spring arm device;

Wherein, preferentially, the displacement of the force point of the spring on the mobile side or on the load arm or on the hinge joint between the mobile side and the load arm is generated by the copular axle driven by the spring and the pull rod;

Wherein, preferentially, the force point of the spring on the mobile side or on the load arm or on the hinge joint between the mobile side and the load arm can be on the pull rod, or on the copular axle or on the retainer;

Wherein, preferentially, the retainer restricts the travel track of the copular axle, and ensures the copular axle changes angle and position during its motion process;

Wherein, preferentially, the copular axle can be a cam. A cam mechanism is composed of the cam, the pull rod and the retainer;

Wherein, preferentially, the copular axle can be a circular shaft and the retainer is provided with one or more guide faces, which ensures that the copular axle, driven by the pull rod, rolls on the guide faces of the retainer;

Wherein, preferentially, the copular axle, driven by the spring and the pull rod, dynamically changes its position and angle.

Through implementation of the above technical scheme, the invention has the technical advantages in that: through a design to the copular axle and the retainer, the spring arm device ensures that the copular axle dynamically changes its position during rolling motion, and gives geometric compensation for the spring's tensile force, thus realizing isoelasticity. The device has the advantages of simplifying structure, reducing production cost, improving reliability and simplifying operation.

### BRIEF DESCRIPTION OF THE DRAWINGS

FIG. 1 is the schematic diagram on the spring arm device provided by the exploit example of the invention, which shows the position status of the copular axle when the spring arm device is at different positions;

FIG. 2 is the schematic diagram on the spring arm device provided by the exploit example of the invention, which shows the position statuses of the copular axle, the pull rod and the spring when the spring arm device is at different positions;

FIG. 3 is the schematic diagram on the spring arm device provided by the exploit example of the invention, which shows the mutual relations of the copular axle of the spring arm, the pull rod and the spring;

FIG. 4 is the schematic diagram on the spring arm device provided by the exploit example of the invention, which shows the internal structure of the spring arm;

FIG. 5 is the schematic diagram on the spring arm device provided by another exploit example of the invention.

### DETAILED DESCRIPTION OF THE INVENTION

In order to better illustrate the technical scheme of the invention, detailed description of the exploit example of the invention is made in combination with the figures as follows:

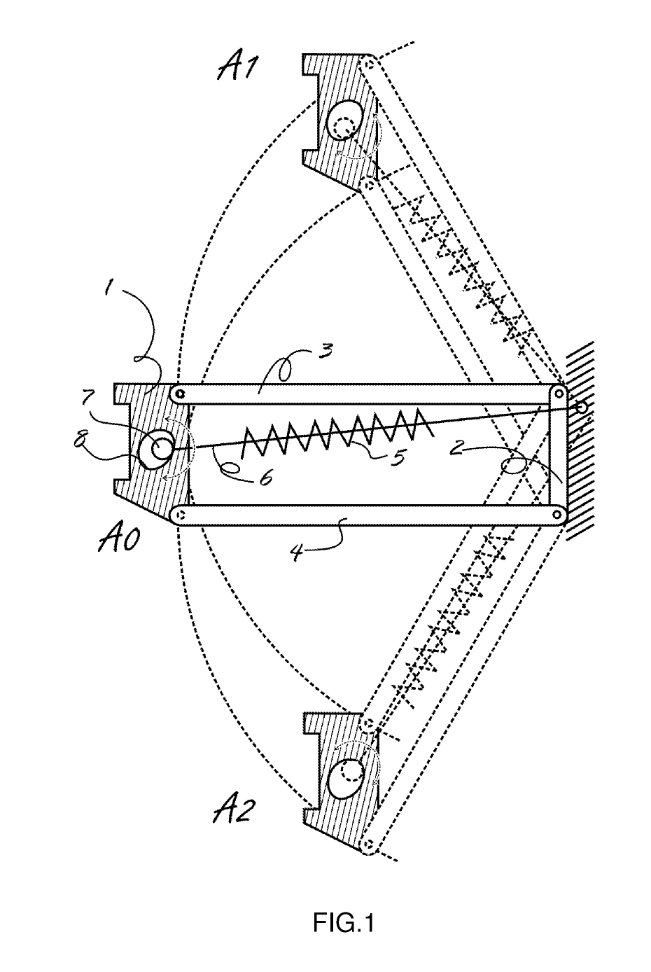

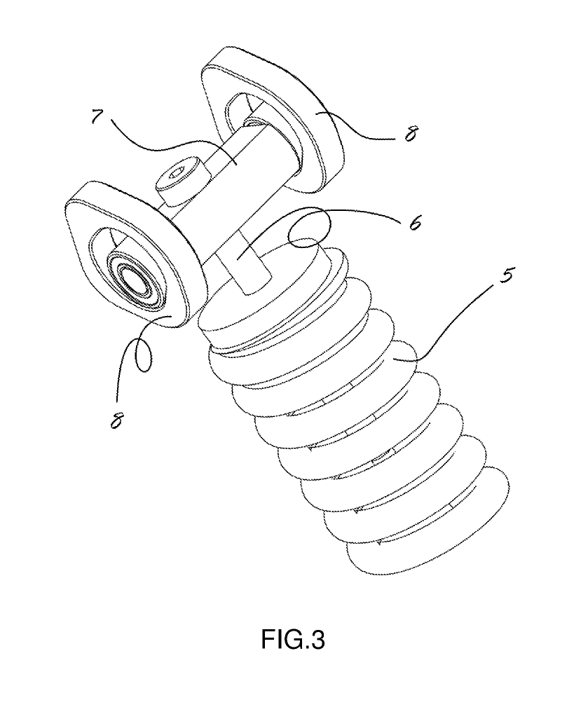

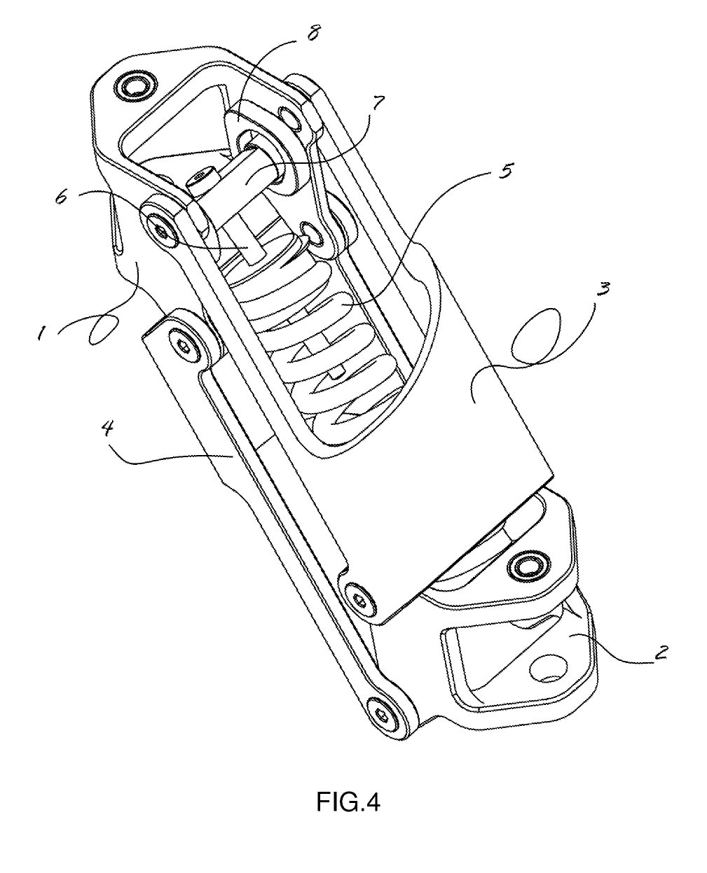

The exploit example of the invention provides the spring arm device as shown from FIG. 1 to FIG. 5. The device comprises the parallelogram linkage mechanism composed of mobile side 1, fixed side 2 in parallel with mobile side 1, upper arm 3 and load arm 4 respectively connected with mobile side 1 and fixed side 2;

One end of spring 5 is connected with fixed side 2 or upper arm 3, while the other end of spring 5 is connected with mobile side 1; spring 5 is diagonally tensioned between fixed side 2 and mobile side 1, or spring 5 is diagonally tensioned between upper arm 3 and mobile side 1.

Specifically, the other end of spring 5 is connected through pull rod 6 with mobile side 1, load arm 4, or the hinge joint between mobile side 1 and load arm 4; in other words, the other end of spring 5 is connected with one end of pull rod 6 while the other end of which is connected with mobile side 1, or load arm 4, or the hinge joint between mobile side 1 and load arm 4.

One end of spring 5 is connected to fixed side 2 or upper arm 3.

Copular axle 7 is used for fixing pull rod 6; and retainer 8 is used for installing copular axle 7.

Retainer 8 is positioned on mobile side 1, or on load arm 4, or on the hinge joint between mobile side 1 and load arm 4.

In the above exploit example, the force point of spring 5 on mobile side 1 or on load arm 4 or at the hinge joint between mobile side 1 and load arm 4 shifts with the motion of the spring arm device.

In the above exploit example, the displacement of force point of spring 5 on mobile side 1 or on load arm 4 or on the hinge joint between mobile side 1 and load arm 4 is generated by copular axle 7 driven by spring 5 and pull rod 6;

In addition, the force point of spring 5 on mobile side 1 can be on pull rod 6, or on copular axle 7 or on retainer 8;

In the above exploit example, retainer 8 restricts the travel track of copular axle 7, and ensures copular axle 7 change angles and positions during motion process. In practical exploit example, copular axle 7 can be a cam. A cam mechanism is composed of the cam, pull rod 6 and retainer 8.

In another exploit example, copular axle 7 can be a circular shaft and retainer 8 is provided with one or more guide faces, which ensures that copular axle 7, driven by pull rod 6, rolls on the guide faces of retainer 8. Under working condition of the spring arm composed of spring 5 and pull rod 6, mobile side 1 of the spring arm moves upward and downward, which drives spring 5 and pull rod 6 to rotate; pull rod 6 drives copular axle 7 to roll along the track restricted by retainer 8, and its position is changeable.

The position and angle of copular axle 7, driven by spring 5 and pull rod 6, change automatically and dynamically, dispensed with manual adjustment during working.

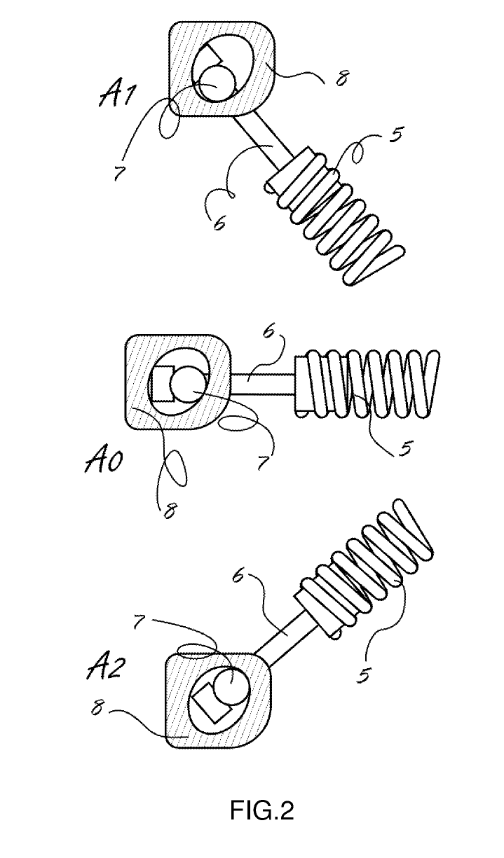

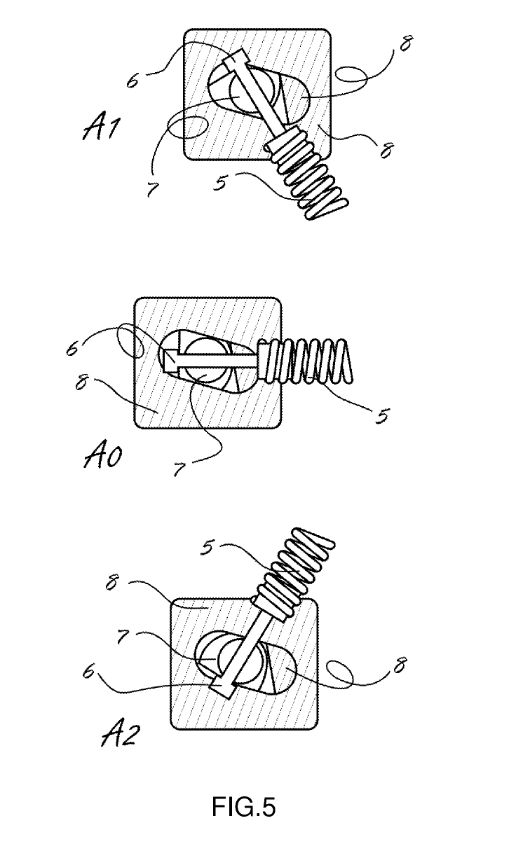

As shown in FIG. 1, FIG. 2 and FIG. 5, position status A0 is the initial position of the spring arm during working. Usually prior to working, operators preset the spring arm at A0 position by means of a spring tensile force adjusting device (this is a prior art, without indication in the Figures). In the course when the spring arm is raised to a high spot A1 or lowered to a low spot A2, copular axle 7 rolls along the track restricted by retainer 8, and its position is changeable.

The above exploit example provided by the invention utilizes geometric compensation principle of spring's tensile force. When the spring arm needs more buoyancy, such as in the rising process of the spring arm, both endpoints of the spring shift toward two opposite directions; when the spring arm needs less buoyancy, such as in the descending process of the spring arm, both endpoints of the spring shift toward each other. In this way, in the rising and descending processes of the spring arm, both endpoints of the spring shift dynamically, which changes the geometric relationship of the spring, thus compensating the spring's tensile force.

Therefore, through a design to the copular axle and the retainer, the spring arm device provided by the exploit example of the invention ensures that the copular axle dynamically changes its position during rolling motion, and gives geometric compensation for the spring's tensile force, thus realizing isoelasticity. The device has the advantages of simplifying structure, reducing production cost, improving reliability and simplifying operation.

What is claimed is:

1. A spring arm device is characterized by comprising:
a parallelogram linkage mechanism composed of a mobile side, a fixed side in parallel with the above-mentioned mobile side, an upper arm and a load arm respectively connected with the above-mentioned mobile side and the above-mentioned fixed side;
a spring, one end of which is connected with the above-mentioned fixed side or the upper arm while the other end is connected with the above-mentioned mobile side or the load arm or the hinge joint between the mobile side and the load arm;
a pull rod used for installing the above-mentioned spring,
a copular axle used for fixing the above-mentioned pull rod and a retainer used for installing the above-mentioned copular axle;
wherein, the retainer is positioned on the mobile side, or on the load arm , or on the hinge joint between the mobile side and the load arm.

2. The spring arm device mentioned in claim 1 is characterized in that the force point of the spring on the mobile side or on the load arm or on the hinge joint between the mobile side and the copular arm shifts with the motion of the spring arm device.

3. The spring arm device mentioned in claim 1 is characterized in that the displacement of force point of the spring on the mobile side or on the load arm or on the hinge joint between the mobile side and the load arm is generated by the copular axle driven by the spring and the pull rod.

4. The spring arm device mentioned in claim 3 is characterized in that the force point of the spring on the mobile side or on the load arm or on the hinge joint between the mobile side and the load arm can fall on the pull rod, or on the copular axle or on the retainer.

5. The spring arm device mentioned in claim 4 is characterized in that the retainer restricts the travel track of the copular axle, and ensures the changes of angle and position of the copular axle during its motion process.

6. The spring arm device mentioned in claim 3, 4 or 5 is characterized in that the copular axle can be a cam. A cam mechanism is composed of the cam, the pull rod and the retainer.

7. The spring arm device mentioned in claim 3, 4 or 5 is characterized in that the copular axle can be a circular shaft and the retainer is provided with one or more guide faces, which ensures that the copular axle, driven by the pull rod, rolls on the guide face of the retainer.

8. The spring arm device mentioned in claim 7 is characterized in that the copular axle, driven by the spring and the pull rod, dynamically changes its position and angle.
